(19) United States
(12) Patent Application Publication
(10) Pub. No.: US 2013/0306847 A1
(43) Pub. Date: Nov. 21, 2013

(54) OPTICAL TRANSMISSION MODULE AND CIRCUIT BOARD INCLUDING SAME

(71) Applicant: BING-HENG LEE, Tu-Cheng (TW)

(72) Inventor: BING-HENG LEE, Tu-Cheng (TW)

(21) Appl. No.: 13/653,603

(22) Filed: Oct. 17, 2012

(30) Foreign Application Priority Data
May 21, 2012 (TW) 101117954

(51) Int. Cl. G01J 1/04; G01J 1/42

(52) U.S. Cl. 250/227.11

(57) ABSTRACT

An exemplary optical transmission module includes a flexible printed circuit board (FPCB). The FPCB includes a first end and a second end, and defines a receiving groove between the first end and the second end. The optical transmission module further includes an electrical-optical converter (E/O converter) set on the FPCB adjacent to the first end, an optical-electrical converter (O/E converter) set on the FPCB adjacent to the second end, an optical waveguide received in the receiving groove, first metal pins set at the first end and electrically connected to the E/O converter, and second metal pins set at the second end and electrically connected to the O/E converter. A circuit board including the optical transmission module is also provided.

### BACKGROUND

1. Technical Field

The present disclosure relates to an optical transmission module and a circuit board including the optical transmission module.

2. Description of Related Art

Flexible optical printed circuit boards (FOPCBs) are used to transmit information in electronic devices because they can transmit more information than traditional printed circuit boards. However, it may not be easy to electrically connect an FOPCB with the circuitry of an electronic device.

Therefore, an optical transmission module which can overcome the above-mentioned problem and a circuit board including the optical transmission module are needed.

### BRIEF DESCRIPTION OF THE DRAWINGS

FIG. 1 is a schematic, top plan view of an optical transmission module according to a first embodiment.

FIG. 2 is a sectional view taking along line II-II of the optical transmission module of FIG. 1.

FIG. 3 is a sectional view of an optical transmission module according to a second embodiment.

FIG. 4 is a sectional view of an optical transmission module according to a third embodiment.

FIG. 5 is a sectional view of an optical transmission module according to a fourth embodiment.

FIG. 6 is a sectional view of part of a circuit board according to a fifth embodiment.

FIG. 7 is a sectional view of part of a circuit board according to a sixth embodiment.

### DETAILED DESCRIPTION

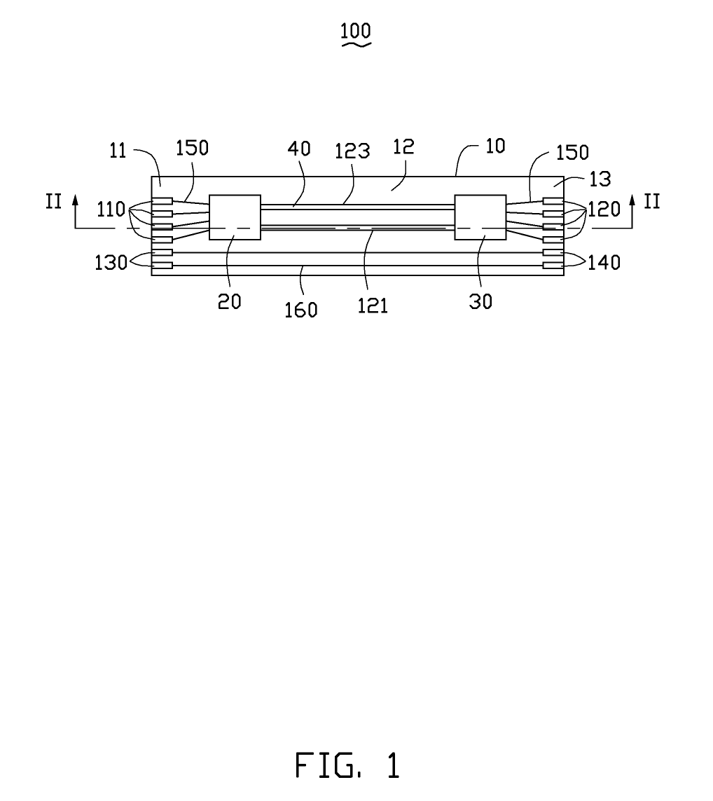

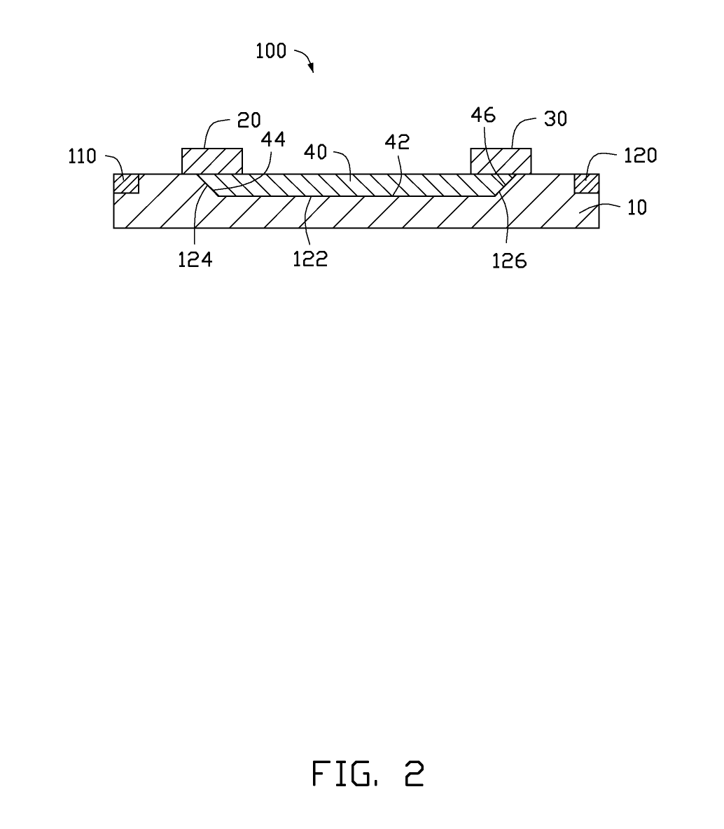

FIGS. 1 and 2 show an optical transmission module 100 according to a first embodiment. The optical transmission module 100 includes a flexible printed circuit board (FPCB) 10, an electrical-optical converter (E/O converter) 20, an optical-electrical converter (O/E converter) 30, and a plurality of optical waveguides 40.

The FPCB 10 includes a major surface 12. The E/O converter 20 and the O/E converter 30 are set on the major surface 12 and are spaced from each other. The E/O converter 20 is capable of emitting a plurality of optical signals.

The major surface 12 defines receiving grooves 121, 123 between the E/O converter 20 and the O/E converter 30. Each of the receiving grooves 121, 123 includes a bottom surface 122, a first reflecting surface 124, and a second reflecting surface 126. The first reflecting surface 124 and the second reflecting surface 126 are positioned at two opposite ends of the bottom surface 122, respectively. An included angle between the first reflecting surface 124 and the bottom surface 122 is equal to an included angle between the second reflecting surface 126 and the bottom surface 122, and is about 135°.

The FPCB 10 includes a first end 11 and an opposite second end 13. A number of first metal pins 110 are set on the first end 11. The first metal pins 110 are connected to the E/O converter 20 via wires 150. A number of second metal pins 120 are set on the second end 13. The second metal pins 120 are connected to the light receiving module 30 via wires 150.

In this embodiment, there are two optical waveguides 40. The two optical waveguides 40 are received in the receiving grooves 121, 123. Each of the optical waveguides 40 includes a main surface 42, a first optical reflecting surface 44, and a second optical reflecting surface 46. The first optical reflecting surface 44 and the second optical reflecting surface 46 are positioned at two opposite ends of the main surface 42, respectively. An included angle between the first optical reflecting surface 44 and the main surface 42 is equal to an included angle between the second optical reflecting surface 46 and the main surface 42, and is about 135°. The main surface 42 is in full contact with the bottom surface 122. The first optical reflecting surface 44 is in full contact with the first reflecting surface 124. The second optical reflecting surface 44 is in full contact with the second reflecting surface 126.

When the optical transmission module 100 is working, the E/O converter 20 emits an optical signal to a given one of the optical waveguides 40. The optical signal is reflected by the first optical reflecting surface 44 to the second optical reflecting surface 46, then reflected by the second optical reflecting surface 46, and finally received by the O/E converter 30.

The light transmission module 100 further includes a number of third metal pins 130 set at the first end 11, and a number of fourth metal pins 140 set at the second end 13. The third metal pins 130 and the fourth metal pins 140 are connected via wires 160. The third metal pins 130, the fourth metal pins 140, and the wires 160 are used for transmitting electrical signals, to provide a secondary information transmission path between the first end 11 and the second end 13.

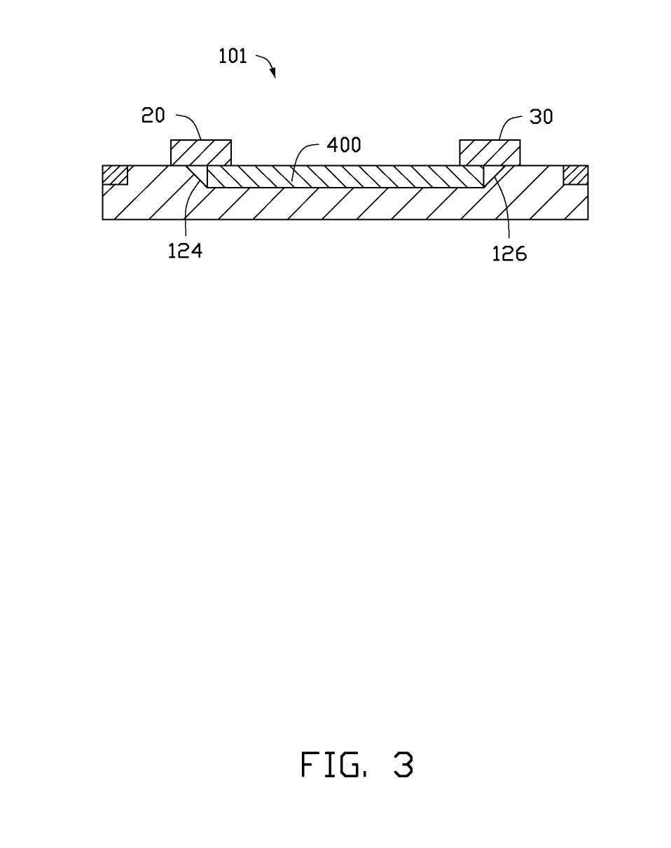

Referring to FIG. 3, an optical transmission module 101 according to a second embodiment is shown. The optical transmission module 101 is similar to the optical transmission module 100 of the first embodiment, except for the shape of the optical waveguides 400. In this embodiment, each optical waveguide 400 is cylindrical, and a longitudinal section of the optical waveguide 400 is rectangular. The optical signal emitted by the E/O converter 20 is reflected by the first reflecting surface 124, then transmitted by the optical waveguide 400, then reflected by the second reflecting surface 126, and finally received by the O/E converter 30.

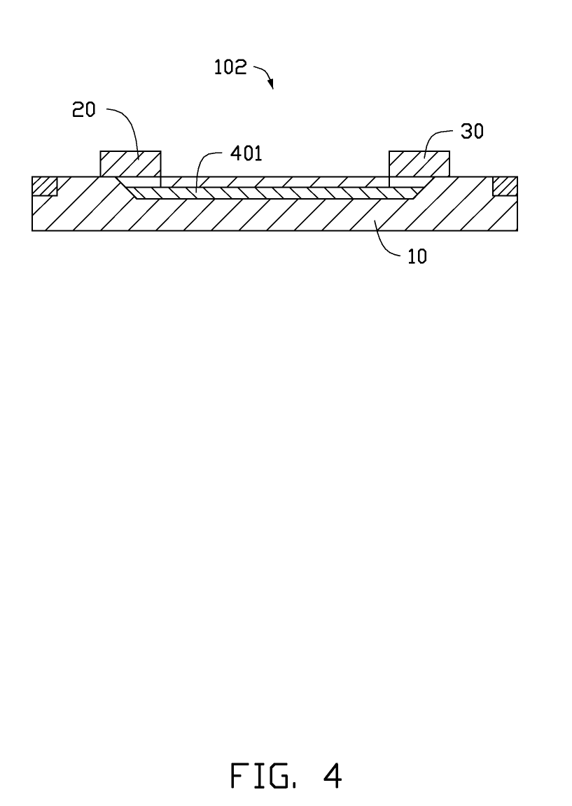

Referring to FIG. 4, an optical transmission module 102 according to a third embodiment is shown. The optical transmission module 102 is similar to the optical transmission module 100 of the first embodiment, except that the optical waveguides 401 are substantially enclosed by the FPCB 10. Only two ends of each optical waveguide 401 are exposed, for receiving the optical signal from the E/O converter 20, and for transmitting the optical signal to the O/E converter 30, respectively. In the illustrated embodiment, a majority of a length of the optical waveguide 401 is covered by the FPCB 10, with two end portions of a top face (not labeled) of the optical waveguide 401 being exposed in the receiving groove (not labeled).

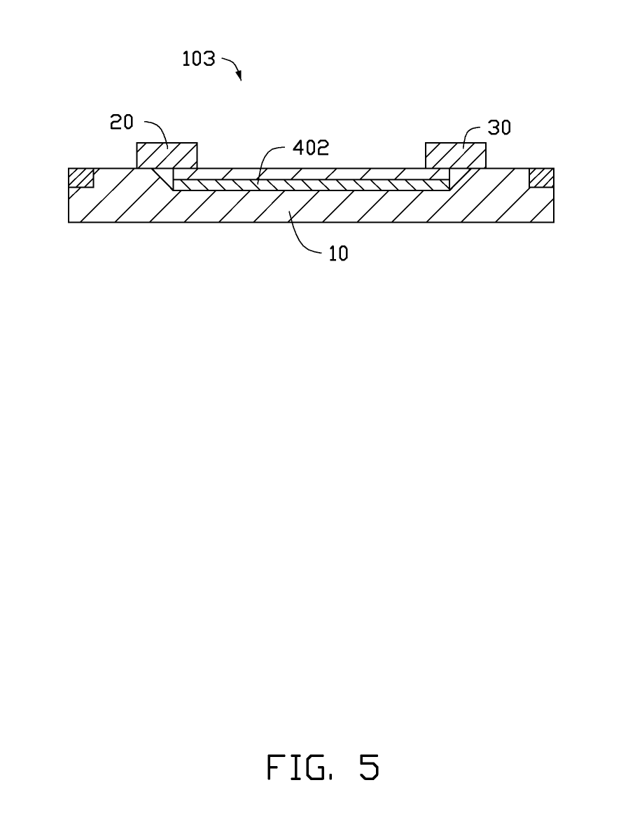

Referring to FIG. 5, an optical transmission module 103 according to a fourth embodiment is shown. The optical transmission module 103 is similar to the optical transmission module 101 of the second embodiment, except that the optical waveguides 402 are substantially enclosed by the FPCB 10. Only two ends of each optical waveguide 402 are exposed, for receiving the optical signal from the E/O converter 20, and for transmitting the optical signal to the O/E converter 30, respectively. In the illustrated embodiment, an entire length of the optical waveguide 402 is covered by the FPCB 10, with two perpendicular end faces (not labeled) of the optical waveguide 402 being exposed in the receiving groove (not labeled).

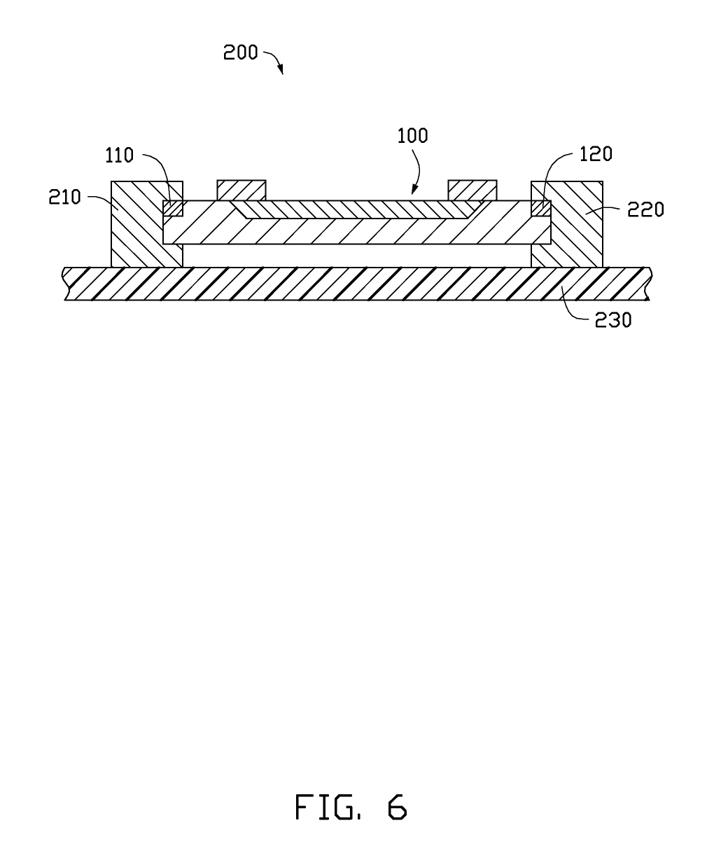

Referring to FIG. 6, a circuit board 200 according to a fifth embodiment is shown. The circuit board 200 includes the optical transmission module 100, a first electrical connector 210, a second electrical connector 220, and a substrate 230. The first electrical connector 210 and the second electrical connector 220 are set on the substrate 230.

The first metal pins 110 and the third metal pins 130 are connected to the first electrical connector 210. The second metal pins 120 and the fourth metal pins 140 are connected to the second electrical connector 220.

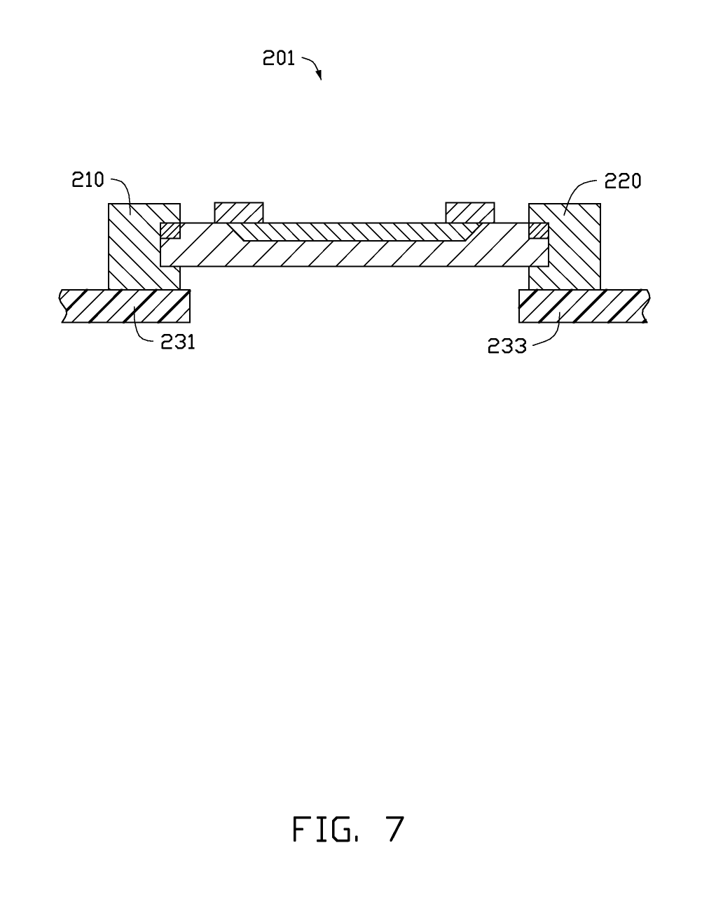

Referring to FIG. 7, a circuit board 201 according to a sixth embodiment is shown. The circuit board 201 is similar to the circuit board 200 of the fifth embodiment, except that the circuit board 201 includes a first substrate 231 and a second substrate 233 spaced from the first substrate 231. The first electrical connector 210 is set on the first substrate 231. The second electrical connector 220 is set on the second substrate 233.

In summary, the optical transmission module 100 includes the E/O converter 20, the O/E converter 30, and the associated wires 150 and metal pins 110, 120. Taking the above-described circuit boards 200, 201 as examples, the configuration of the optical transmission module 100 makes it easy to electrically connect the optical transmission module 100 with the first electrical connector 210 and the second electrical connector 220.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An optical transmission module, comprising:
a flexible printed circuit board (FPCB) comprising a first end and a second end, and defining a receiving groove between the first end and the second end;
an electrical-optical converter (E/O converter) set on the FPCB adjacent to the first end, the E/O converter being configured for emitting an optical signal;
an optical-electrical converter (O/E converter) set on the FPCB adjacent to the second end;
an optical waveguide received in the receiving groove and positioned for transmitting the optical signal from the E/O converter to the O/E converter;
a plurality of first metal pins set at the first end and electrically connected to the E/O converter; and
a plurality of second metal pins set at the second end and electrically connected to the O/E converter.

2. The optical transmission module of claim 1, wherein the receiving groove comprises a bottom surface, a first reflecting surface at one end of the bottom surface, and a second reflecting surface at an opposite end of the bottom surface; and an included angle between the first reflecting surface and the bottom surface is equal to an included angle between the second reflecting surface and the bottom surface, and is about 135°.

3. The optical transmission module of claim 1, wherein the optical waveguide comprises a main surface, a first optical reflecting surface at one end of the main surface, and a second optical reflecting surface at an opposite end of the main surface; and an included angle between the first optical reflecting surface and the main surface is equal to an included angle between the second optical reflecting surface and the main surface, and is about 135°.

4. The optical transmission module of claim 3, wherein the optical waveguide is substantially enclosed by the FPCB, with only two ends of the optical waveguide being exposed, the ends of the optical waveguide positioned for receiving the optical signal from the E/O converter, and for transmitting the optical signal to the O/E converter, respectively.

5. The optical transmission module of claim 1, wherein the optical waveguide is cylindrical, and a longitudinal section of the optical waveguide is rectangular.

6. The optical transmission module of claim 5, wherein the optical waveguide is substantially enclosed by the FPCB, with only two ends of the optical waveguide being exposed, the ends of the optical waveguide positioned for receiving the optical signal from the E/O converter, and for transmitting the optical signal to the O/E converter, respectively.

7. The optical transmission module of claim 1, further comprising a plurality of third metal pins set on the first end, a plurality of fourth metal pins set on the second end, and a plurality of wires, wherein the third metal pins are electrically connected to the fourth metal pins by the wires.

8. A circuit board, comprising:
an optical transmission module comprising:
a flexible printed circuit board (FPCB) comprising a first end and a second end, and defining a receiving groove between the first end and the second end;
an electrical-optical converter (E/O converter) set on the FPCB adjacent to the first end, the E/O converter being configured for emitting an optical signal;
an optical-electrical converter (O/E converter) set on the FPCB adjacent to the second end;
an optical waveguide received in the receiving groove and positioned for transmitting the optical signal from the E/O converter to the O/E converter;
a plurality of first metal pins set at the first end and electrically connected to the E/O converter; and
a plurality of second metal pins set at the second end and electrically connected to the O/E converter;
a first electrical connector electrically connected to the first metal pins; and
a second electrical connector electrically connected to the second metal pins.

9. The circuit board of claim 8, wherein the receiving groove comprises a bottom surface, a first reflecting surface at one end of the bottom surface, and a second reflecting surface at an opposite end of the bottom surface; and an included angle between the first reflecting surface and the bottom surface is equal to an included angle between the second reflecting surface and the bottom surface, and is about 135°.

10. The circuit board of claim 8, wherein the optical waveguide comprises a main surface, a first optical reflecting surface at one end of the main surface, and a second optical reflecting surface at an opposite end of the main surface; and an included angle between the first optical reflecting surface and the main surface is equal to an included angle between the second optical reflecting surface and the main surface, and is about 135°.

11. The circuit board of claim 8, wherein the optical transmission module further comprises a plurality of third metal pins set at the first end, a plurality of fourth metal pins set at the second end, and a plurality of wires, the third metal pins are electrically connected to the fourth metal pins by the wires, the third metal pins are electrically connected to the first electrical connector, and the fourth metal pins are electrically connected to the second electrical connector.

12. The circuit board of claim 8, further comprising a substrate on which the first electrical connector and the second electrical connector are set.

13. The circuit board of claim 8, further comprising a first substrate on which the first electrical connector is set, and a second substrate on which the second electrical connector is set, wherein the first and second substrates are spaced from each other.

14. An optical transmission module, comprising:
a flexible printed circuit board (FPCB) comprising a first end and a second end, and defining a plurality of receiving grooves between the first end and the second end;
an electrical-optical converter (E/O converter) set on the FPCB adjacent to the first end, the E/O converter being configured for emitting a plurality of optical signals;
an optical-electrical converter (O/E converter) set on the FPCB adjacent to the second end;
a plurality of optical waveguides received in the receiving grooves and positioned for transmitting the optical signals from the E/O converter to the O/E converter;
a plurality of first metal pins set at the first end and electrically connected to the E/O converter; and
a plurality of second metal pins set at the second end and electrically connected to the O/E converter.

15. The optical transmission module of claim 14, wherein each of the receiving grooves comprises a bottom surface, a first reflecting surface at one end of the bottom surface, and a second reflecting surface at an opposite end of the bottom surface; and an included angle between the first reflecting surface and the bottom surface is equal to an included angle between the second reflecting surface and the bottom surface, and is about 135°.

16. The optical transmission module of claim 14, wherein each of the optical waveguides comprises a main surface, a first optical reflecting surface at one end of the main surface, and a second optical reflecting surface at an opposite end of the main surface, and an included angle between the first optical reflecting surface and the main surface is equal to an included angle between the second optical reflecting surface and the main surface, and is about 135°.

17. The optical transmission module of claim 14, further comprising a plurality of third metal pins set on the first end, a plurality of fourth metal pins set on the second end, and a plurality of wires, wherein the third metal pins are electrically connected to the fourth metal pins by the wires.
